(19) United States
(12) Patent Application Publication
(10) Pub. No.: US 2005/0097728 A1
(43) Pub. Date: May 12, 2005

(54) Contact start detecting apparatus for mounting process apparatus, and mounting process apparatus provided with the same

(75) Inventors: Masatoshi Ito, Tokyo (JP); Toshinobu Miyagoshi, Tokyo (JP); Akihiko Miura, Tokyo (JP); Hiroshi Ikeda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/976,765

(22) Filed: Nov. 1, 2004

(30) Foreign Application Priority Data
Nov. 6, 2003 (JP) 2003-376427

(51) Int. Cl. B23P 19/00

(52) U.S. Cl. 29/739; 29/740

(57) ABSTRACT

The present invention has as its object to realize both of the higher accuracy of the detection of contact between a mounting part and a part to be mounted and an improvement in the stability of the detection at a high level. For this purpose, the present invention is comprised of a contact start detecting member designed to move in operative association with moving means for moving at least one of the mounting part and the part to be mounted toward the other until the mounting part and the part to be mounted contact with each other, and on the other hand, when the mounting part and the part to be mounted have contacted with each other, to have its operative association with the moving means released in response to the action of the contact pressure thereof and be movable independently of the moving means, and contact start detecting means for detecting the movement of the contact start detecting member to thereby detect the start of contact between the mounting part and the part to be mounted.

### BACKGROUND OF THE INVENTION

1. Field of the Invention

This invention relates to a contact start detecting apparatus for detecting the start of contact between a mounting part and a part to be mounted used in a mounting process apparatus for carrying out predetermined processing with the mounting part and the part to be mounted brought into predetermined contact with each other, such as mounting a mounting part (an electronic part such as a flip chip on a part to be mounted (such as a substrate), and a mounting process apparatus comprised of the same apparatus.

2. Related Background Art

Heretofore, in an apparatus of this kind, an electronic part held by a chip holding tool has been lowered toward a substrate, and after the electronic part has come into contact with the substrate, ultrasonic joint has been effected while the electronic part is pushed onto the substrate by a predetermined amount.

Accordingly, it is required to actually detect the start of contact between the substrate and the electronic part, and accurately grasp the contact start position of the substrate and the electronic part.

Here, what is disclosed in Japanese Patent Application Laid-Open No. 2000-174498 detects any change in torque acting on a chip holding tool for holding an electronic part on the basis of a current value flowing to a voice coil motor (VCM) for driving the chip holding tool, thereby effecting the detection of the start of contact between the electronic part and a substrate.

Also, what is disclosed in Japanese Patent Application Laid-Open No. 2000-286280 is provided with pressure force detecting means such as, for example, a load cell, and is adapted to detect any change in a pressure force detected by the pressure force detecting means to thereby detect the start of contact between an electronic part and a substrate.

What is disclosed in Japanese Patent Application Laid-Open No. 2000-22396 is adapted to detect the start of contact between an electronic part and a substrate on the basis of the driving current waveform of a servo-motor for driving a chip holding tool for holding the electronic part, and an acceleration waveform obtained by differentiating the rotational speed of the servo-motor.

Further, what is disclosed in Japanese Patent Application No. 2002-240588 proposed by the applicant is adapted to detect contact pressure produced between a mounting part and a part to be mounted by contact start detecting means comprised of a load cell or the like, and detect the start of contact on the basis of any change in the contact pressure.

Now, in the apparatus wherein as in the prior art, the start of contact between the electronic part and the substrate is detected on the basis of the detection value of the driving current of the motor or the detection value of the load cell, to enable the start of contact to be accurately detected, it is necessary to increase the detection resolving power of the detector so as to enable minute displacement to be accurately detected. However, if the detection resolving power of the detector is increased, when for example, the load on a mounting nozzle side is lightened, the apparatus becomes liable to be affected by mechanical vibration, the resolving power of the detector, the fluctuation of the torque of a mechanical sliding portion, etc., and this leads to the problem that wrong detection becomes liable to occur to the detector.

It is also required to stabilize the detection, but to meet such a requirement, it is necessary to lower the detection resolving power of the detector, or it is necessary to apply to the electronic part such a stable load as will make stable detection possible, and this runs counter to the aforedescribed improvement in detection accuracy, or may give more than necessary pressure force and stress to the electronic part.

### SUMMARY OF THE INVENTION

The present invention has been made in view of such situation of the prior art, and has as its object to provide a contact start detecting apparatus for a mounting process apparatus which can realize both of the higher accuracy of the detection of contact between a mounting part and a part to be mounted and an improvement in the stability of the detection at a high level, and a mounting process apparatus provided with the same.

For this purpose, the contact start detecting apparatus for a mounting process apparatus according to the present invention is comprised of:
a contact start detecting member adapted to move in operative association with moving means for moving at least one of a mounting part and a part to be mounted toward the other until the mounting part and the part to be mounted contact with each other, and on the other hand, when the mounting part and the part to be mounted have contacted with each other, to have its operative association with the moving means released in response to the action of the contact pressure thereof and be movable independently of the moving means; and
contact start detecting means for detecting the movement of the contact start detecting member to thereby detect the start of contact between the mounting part and the part to be mounted.

As described above, in the present invention, design is made such that the start of contact between the mounting part and the part to be mounted is detected on the basis of the movement of the contact start detecting member and therefore, as compared with the prior art in which the start of contact between the electronic part and the substrate is detected on the basis of the detection value of the driving current of the motor or the detection value of the load cell, the stability of the detection is made high in level and yet, the start of contact can be detected highly accurately, whereby the higher accuracy and further, higher quality of the mounting process can be achieved.

Also, the contact start detecting apparatus for the mounting process apparatus according to the present invention can be made into a construction in which the contact start detecting means detects the start of contact between the mounting part and the part to be mounted on the basis of the relative movement of one portion of the contact start detecting means disposed on the moving means and other portion of the contact start detecting means disposed on the contact start detecting member.

Also, in the contact start detecting apparatus for the mounting process apparatus according to the present invention, one of the aforementioned one portion and the other portion can be constructed as a detecting head comprised of a light source, a condensing lens and a light receiving element, and the other can be constructed as a scale unit comprised of a scale portion and movable relative to the detecting head.

The mounting process apparatus according to the present invention is comprised of any one of the above-described contact start detecting apparatuses for the mounting process apparatus, and is designed to process the mounting part and the part to be mounted of the contact start detecting apparatus for the mounting process apparatus in a predetermined manner on the basis of the result of the detection of the start of contact between the mounting part and the part to be mounted.

According to the present invention provided with such a construction, as compared with the prior art in which the start of contact between the electronic part and the substrate is detected on the basis of the detection value of the driving current of the motor or the detection value of the load cell, the stability of the detection can be high in level and yet, the start of contact can be detected highly accurately, whereby the higher accuracy and further, higher quality of the mounting process can be achieved.

Also, the mounting process apparatus according to the present invention is comprised of:
mounting part holding means for holding a mounting part;
mounted part holding means for holding a part to be mounted;
moving means for moving at least one of the mounting part holding means and the mounted part holding means toward the other;
pressurizing means capable of causing an output member to act on one of the mounting part and the part to be mounted, and imparting a predetermined pressure force to between the mounting part and the part to be mounted contacting with each other;
regulating means for supporting the output member from a direction opposed to a pressurizing direction, and regulating the movement of the output member relative to the supporting portion in the pressurizing direction;
control means for bringing the mounting part and the part to be mounted into contact with each other through the moving means with the output member urged against the regulating means by the pressurizing means, moving the output member relative to the supporting portion by the contact pressure against the predetermined pressure force to thereby release the support by the regulating means, and processing the mounting part and the part to be mounted in a predetermined manner while imparting a predetermined pressure force through the output member of the pressurizing means; and
means for detecting the movement of the output member relative to the supporting portion by the contact pressure against the predetermined pressure force to thereby detect the start of contact between the mounting part and the part to be mounted; and
is characterized in that the control means processes the mounting part and the part to be mounted in a predetermined manner on the basis of the detection information of the means for detecting the start of contact between the mounting part and the part to be mounted while imparting the predetermined pressure force through the output member of the pressurizing means.

The mounting process apparatus provided with such a construction as makes the output member of the pressurizing means function as a contact start detecting member, and can detect the start of contact between the mounting part and the part to be mounted on the basis of the movement of this output member. Accordingly, it can promote the simplification of the construction and yet, as compared with the prior art in which the start of contact between the electronic part and the substrate is detected on the basis of the detection value of the driving current of the motor or the detection value of the load cell, the stability of the detection can be made high in level and yet, the start of contact can be highly accurately detected, whereby the higher accuracy and further, higher quality of the mounting process can be achieved.

Also, in the mounting process apparatus according to the present invention, the means for detecting the start of contact between the mounting part and the part to be mounted can be comprised of a detecting head comprised of a light source, a condensing lens and a light receiving element, and disposed on one of the output member and the regulating means, and a scale unit comprised of a scale portion and movable relative to the detecting head, and disposed on the other.

### BRIEF DESCRIPTION OF THE DRAWINGS

FIG. 1 schematically illustrates the construction of a mounting process apparatus according to an embodiment of the present invention.

FIG. 2 is a time chart illustrating the mounting process operation (the blocking of vertical movement, changes in the output of a linear scale, and the operation of a locking solenoid) according to the same embodiment.

FIG. 3 illustrates the operation of a chip holding tool in the mounting process according to the same embodiment.

FIG. 4 is a flow chart illustrating an example of the mounting process according to the same embodiment.

### DESCRIPTION OF THE PREFERRED EMBODIMENTS

An embodiment of the present invention will hereinafter be described with reference to the accompanying drawings.

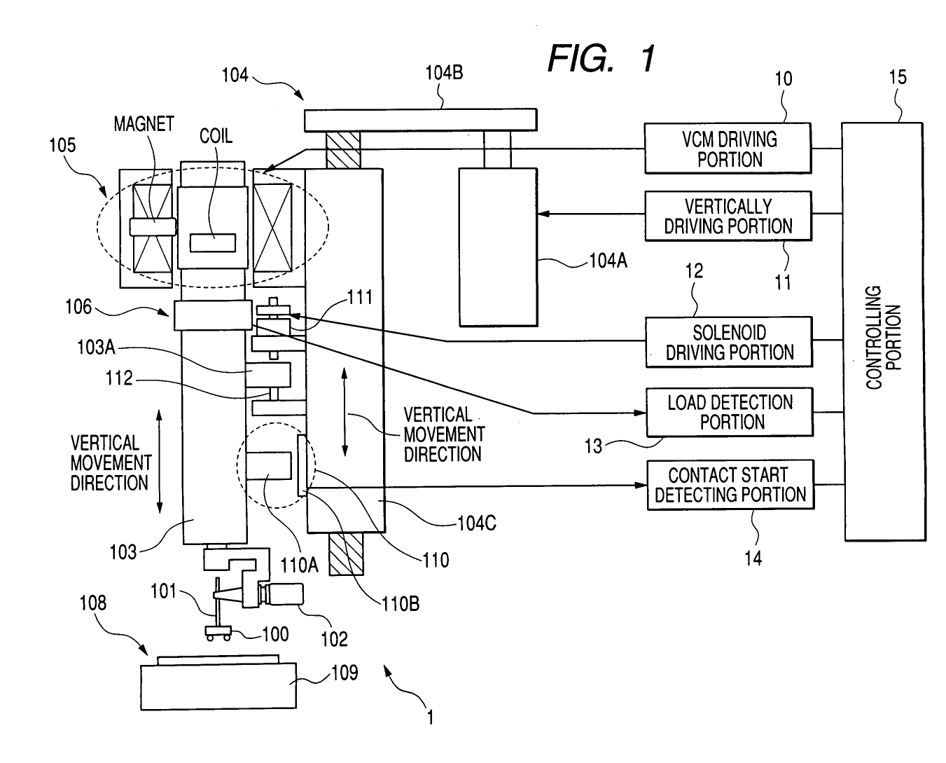

As shown in FIG. 1, in a mounting process apparatus 1 according to an embodiment of the present invention, a chip holding tool 101 for holding an electronic part 100 by a method such as vacuum adsorption is mounted on an ultrasonic horn 102, which in turn is mounted on a shaft 103 through an adapter or the like.

The shaft 103 is connected to a vertically driving mechanism 104 (a vertically driving portion 11) through a voice coil motor 105 (VCM driving portion 10) having its shaft 103 drive-controlled in a vertical direction as viewed in FIG. 1 by a driving signal from a controlling portion 15, and by this vertically driving mechanism 104, the shaft 10 is movable relative to a substrate 108 and substrate holding means 109 in a vertical direction as viewed in FIG. 1.

The chip holding tool 101 corresponds to mounting part holding means according to the present invention, and the substrate holding means 109 corresponds to mounted part holding means according to the present invention. Also, the shaft 103 and the chip holding tool 101 correspond to an output member according to the present invention, and the voice coil motor 105 corresponds to pressurizing means.

The vertically driving mechanism 104 (vertically driving portion 11) is designed to drive a Z-axis servo-motor 104A on the basis of the driving signal from the controlling portion 15, and to be capable of moving a vertically moving block 104C rotatably connected to the Z-axis servo-motor 104A through a pulley 104B in a vertical direction as viewed in FIG. 1. Here, the vertically driving mechanism 104 (particularly the vertically moving block 104C) corresponds to moving means according to the present invention.

Also, load detecting means 106 (a load detecting portion 14) comprised of a strain gauge or a load cell or the like is provided on the shaft 103, whereby a load produced between the electronic part and the substrate 108 held by the substrate holding means 109 (the substrate 108 may be capable of carrying one or more electronic parts thereon) can be detected. The detection signal of the load detecting means 106 (load detecting portion 14) is inputted to the controlling portion 15 which functions as controlling means according to the present invention.

Further, in the present embodiment, there is provided contact start detecting means 110 (a contact start detecting portion 14) for detecting the start of contact between the electronic part 100 held by the chip holding tool 101 and the substrate 108 held by the substrate holding means 109.

The contact start detecting means 110 can be comprised of a linear scale. In the present embodiment, ST422 series produced by Mitutoyo Corporation is used as the contact start detecting means 110. This is a separate type linear scale of an optical reflection type linear encoder type, and is comprised of a detecting head 110A comprised of a laser diode, a condensing lens, a light receiving element, etc., and a scale unit 110B constructed discretely from the detecting head 110A and disposed for movement relative to the detecting head 110A. The detection signal of this contact start detecting means 110 (contact start detecting portion 14) is inputted to the controlling portion 15.

The controlling portion 15 is comprised of a CPU, a ROM, a RAM, an A/D converter, various kinds of I/F, etc., and carries out various calculating processes on the basis of a predetermined program based on various kinds of information such as input signals from the load detecting means 106, the contact start detecting means 110, etc. and, for example, other input signal and a stored value and sends a driving signal to the vertically driving mechanism 104, the voice coil motor 105, a locking solenoid 111 which will be described later, etc. to thereby control the driving thereof, and also sends a driving signal to the ultrasonic horn 102 to thereby control the driving of the ultrasonic horn 102.

Here, description will be made of the operation of the mounting process performed by the mounting process apparatus 1 according to the present embodiment.

(1) The locking solenoid 111 (solenoid driving portion 12) integrally mounted on the vertically moving block 104C is driven to thereby urge an arm 103A extending in a direction substantially from the shaft 103 orthogonal to the lengthwise direction thereof (vertical direction as viewed in FIG. 1) against a stopper 112 integrally mounted on the vertically moving block 104C with a predetermined pressure force. Thereby, a floating movement such as the backlash of the shaft 103 resulting from the movement of a head portion (not shown) on which the vertically driving mechanism 104 is disposed is regulated. The stopper 112 corresponds to regulating means according to the present invention.

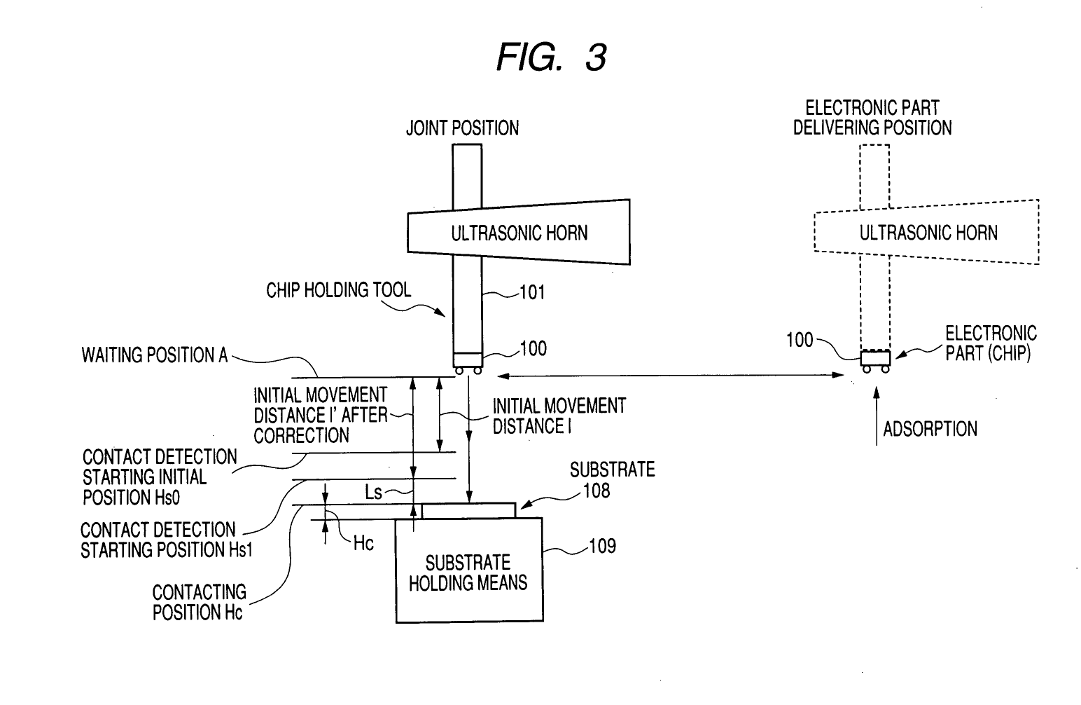

(2) The head portion is moved to a predetermined electronic part delivering position (see FIG. 3), and the electronic part 100 is held as by adsorption by the chip holding tool 101.

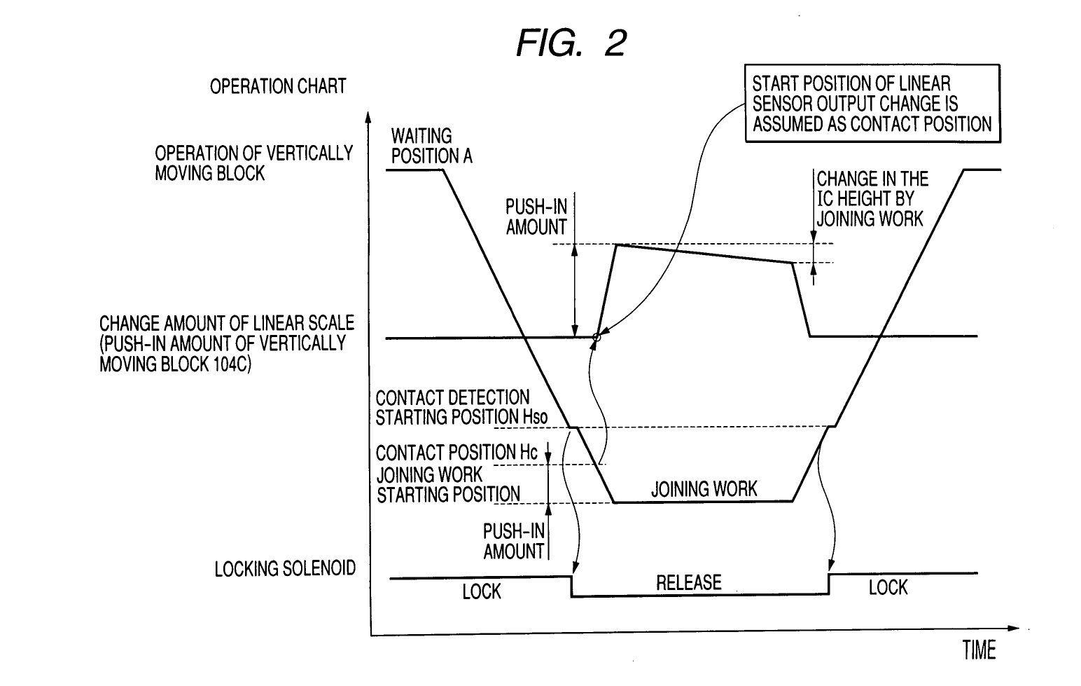

(3) The head portion is moved to thereby move the electronic part 100 held by the chip holding tool 101 to a predetermined waiting position A (see FIGS. 2 and 3) above the substrate 108 held by the substrate holding means 109.

(4) The Z-axis servo-motor 104A is driven to thereby lower the electronic part 100 held by the chip holding tool 101 to a contact detection starting position HsO (a position for starting an operation for detecting the contact between the electronic part and the substrate: see FIGS. 2 and 3). From the waiting position A to the contact detection starting position HsO, it is desired to lower the electronic part at a relatively high speed in order to shorten a tact time or the like as much as possible and therefore, it is desirable at set the contact detection starting position HsO to a position as near as possible to the substrate 108, but since there is the unevenness of the distance between the electronic part 100 and the substrate 108 due to the irregularity or the like of products, the contact detection starting position HsO can be set at such a position as can reliably avoid the occurrence of unexpected contact between the electronic part 100 and the substrate 108, and can sufficiently secure a contact detection distance Ls to maintain contact detection accuracy (a position relatively far from the substrate 108).

(5) An electronic current supplied to the voice coil motor 105 is set so that the load when the electronic part 100 contacts with the substrate 108 may assume a set value, and the locking solenoid 111 is released.

More particularly, a current value supplied to the voice coil motor 105 (i.e., the produced torque of the voice coil motor 105) is set so that the load acting on the electronic part 100 held by the chip holding tool 101 during the contact thereof with the substrate 108 may assume a set value (e.g. of the order of 10-10 g).
“Set value”=“weight of nozzle portion”+“voice coil motor torque”

When the weight of the nozzle portion (the total weight of the shaft 103, the chip holding tool 101, the ultrasonic horn 102, the electronic part 100 and the detecting head 110A) is equal to or greater than a set value, the voice coil motor 105 produces torque traveling upwardly as viewed in FIG. 1 (torque in a pull-up direction).

That is, for example, the weight is set as follows.
“Set value (i.e., a load allowed during the contact between the electronic part and the substrate)”=50 g

Assuming that
“Weight of nozzle portion”=1000 g, the voice coil motor torque is set to
“voice coil motor torque”=−950 g (torque in a pull-up direction upwardly acting as viewed in FIG. 1).

(6) The Z-axis servo-motor 104A is driven to thereby lower the vertically moving block 104C.

(7) When the lowering of the vertically moving block 104C progresses and the electronic part 100 held by the chip holding tool 101 contacts with the substrate 108 held by the substrate holding means 109, the chip holding tool 101 and further, the electronic part 100 so far operatively associated with the lowering operation of the vertically moving block 104C are stopped at the contacting position, and only the vertically moving block 104C continues its lowering operation. Thus, the scale unit 110B mounted on the vertically moving block 104C, and the detecting head 110A mounted on the shaft 103 are moved in opposite directions (that is, the arm 103A of the shaft 103 separates from the stopper 112 with which it has so far been operatively associated and floats upwardly), and the linear scale 110 detects the change (i.e., the start of contact between the electronic part 100 and the substrate 108) (see FIG. 2).

In the present embodiment, design is made such that the shaft 103 (i.e., the output member of the pressurizing means) which is the output shaft of the voice coil motor 105 functions as a contact start detecting member according to the present invention.

(8) In the foregoing (7), when the vertically moving block 104C is lowered after the electronic part 100 has contacted with the substrate 108, only the vertically moving block 104C continues its lowering operation, and the lowering operation of the vertically moving block 104C is continued by an amount corresponding to a predetermined push-in amount (see “the push-in amount of the vertically moving block 104C” in FIG. 2: e.g. of the order of 300 μm). In order words, after the electronic part 100 has contacted with the substrate 108, the height position of the electronic part 100 relative to the substrate 108 does not change, and the arm 103A of the shaft 103 separates upwardly and floats by the amount corresponding to the aforementioned push-in amount from the stopper 112 with which it has so far been operatively associated.

(9) The driving of the ultrasonic horn 102 is controlled to thereby effect the ultrasonic joint of the electronic part 100 and the substrate 108.

During the time when the ultrasonic joint is effected, the driving force of the voice coil motor 105 is adjusted while the output value of the linear scale 110 and the load detection value of the load detecting means 106 are monitored, whereby the contact pressure between the electronic part 100 and the substrate 108 can be controlled to a predetermined target value. As indicated by the “change in the IC height by joining work” shown, for example, in FIG. 2, the height of the electronic part 100 (IC chip) urged against the substrate 108 side gradually becomes low by this joining work and finally, becomes lower by e.g. 30-50 μm relative to the position at the start of the work.

(10) After the completion of the ultrasonic joint, the Z-axis servo-motor 104A is driven to thereby elevate the chip holding tool 101 to the contact detection starting position HsO.

(11) The locking solenoid 111 is driven to thereby urge the arm 103A against the stopper 112 with a predetermined pressure force and regulate the floating movement of the shaft 103.

(12) The Z-axis servo-motor 104A is driven to elevate the vertically moving block 104C to the waiting position A, thus terminating the mounting process.

As described above, in the present embodiment, design is made such that the start of the contact between the electronic part 100 held by the chip holding tool 101 and the substrate 108 held by the substrate holding means 109 is detected by the use of the linear scale and therefore, as compared with the prior art in which the start of the contact between the electronic part and the substrate is detected on the basis of the detection value of the driving current of the motor or the detection value of the load cell, the stability of the detection can be made high in level and yet, the start of the contact can be highly accurately detected.

The apparatus can also be comprised of contact start position detecting means 112 for detecting the position of the electronic part 100 during the contact thereof with the substrate 108 held by the substrate holding means 109, i.e., the contacting position Hc (the distance from the predetermined reference position of the substrate holding means 109 to the non-processing plane of the substrate 108: see FIG. 3) on the basis of the amount of vertical movement of the shaft 103 (vertically moving block 104C) from the waiting position A (which can be obtained, for example, by detecting the driving amount of the Z-axis servo-motor 104A through an encoder or the like, or the amount of movement can be directly detected by the use of a linear gauge or the like), and design can also be made such that on the basis of the contacting position Hc actually detected in the following manner, the contact detection starting position HsO is corrected, for example, in each mounting process.

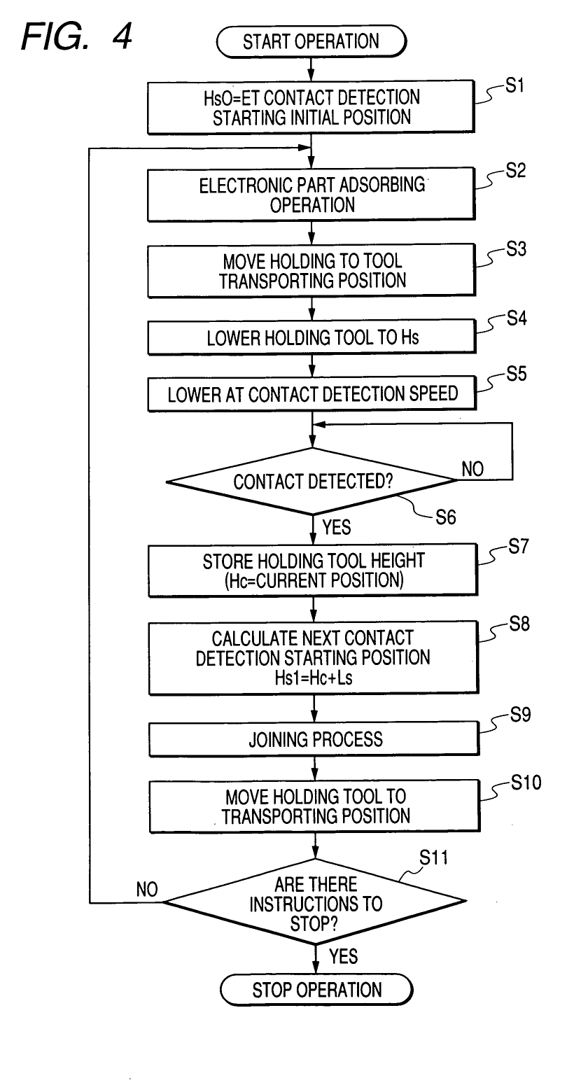

Here, the mounting process carried out in the present embodiment, including the control of correcting the contact detection starting position HsO in each mounting process, will be described in greater detail with reference to the flow chart of FIG. 4.

At a step (in FIG. 4, written as S, and likewise hereinafter) 1 shown in FIG. 4, the controlling portion 15 carries out processing similar to that of the item (1) above, and also sets HsO (the contact detection starting initial position: see FIGS. 2 and 3) on the basis of pre-stored information.

At a step 2, as in the item (2) above, the controlling portion 15 moves the vertically driving mechanism 104 to the electronic part delivering position (see FIG. 3) on the basis of pre-stored information or the like, and causes the electronic part 100 to be adsorbed to and supported by the chip holding tool 101.

At a step 3, as in the item (3) above, the chip holding tool 101 and further, the electronic part 100 adsorbed to and supported by this chip holding tool 101 are moved to the waiting position A shown in FIG. 2.

At a step 4, as in the item (4) above, the chip holding tool 101 is lowered from the waiting position A to the contact detection starting initial position HsO at a relatively high speed for the shortening or the like of the tact time.

At a step 5, when the chip holding tool 101 has been lowered to the contact detection starting initial position HsO, as in the item (5) above, the locking solenoid 111 is released and also, the lowering speed is changed to a preset relatively low contact detection speed.

At a step 6, whether the electronic part 100 adsorbed to and supported by the chip holding tool 101 has contacted with the substrate 108 is judged. This judgment is done by a method similar to that of the item (7) above. If at this step 6, “YES” is judged, advance is made to a step 7, and if “NO” is judged, this step 6 is repeated until contact is detected.

At the step 7, which is a case where the contact has been detected, therefore, the current height direction position (actual contacting position) Hc of the chip holding tool 101 is detected and stored. The contacting position Hc can be detected on the basis of the detection signal of the contact start position detecting means 110.

At a step 8, the next contact detection starting position Hs1 is calculated. This next contact detection starting position Hs1 can be calculated on the basis of the detected actual contacting position Hc and a contact detection distance Ls necessary to secure preset contact detection accuracy. In order reflect the thus obtained next contact detection starting position Hs1 in the next and subsequent processing, Hs1 is set to HsO (HsO←Hs1). It is preferable in achieving the compatibility of the maintenance of detection accuracy and a reduction in the tact time that the contact detection distance Ls be set to a smallest possible value which can maintain the desired accuracy of contact detection.

At a step 9, as in the item (8) above, the vertically moving block 104C is lowered by an amount corresponding to the predetermined push-in amount (see “the push-in amount of the vertically moving block 104C in FIG. 2: e.g. of the order of 300 μm) (the arm 103A of the shaft 103 is upwardly separated and floated from the stopper 112 with which it has so far been operatively associated by an amount corresponding to the “push-in amount” in FIG. 2), and the driving of the ultrasonic horn 102 is controlled and the ultrasonic joint of the electronic part 100 and the substrate 108 is effected.

At a step 10, after the completion of the ultrasonic joint, the Z-axis servo-motor 104A is driven to thereby elevate the chip holding tool 101 to the contact detection starting position HsO (HsO before or after substituted for Hs1 obtained at the step 8). Thereafter, the locking solenoid 111 is driven to thereby urge the arm 103A against the stopper 112 with a predetermined pressure force, and the Z-axis servo-motor 104A is driven while the floating movement of the shaft 103 is regulated, thereby elevating the vertically moving block 104C to the predetermined waiting position A, thus terminating the mounting process.

At a step 11, whether there are instructions to stop is judged. If the answer is “YES”, the present flow is terminated, and if the answer is “NO”, return is made to the step 2, where the joining process is repeated.

If design is made such that as described above, the position at which the electronic part 100 actually starts to contact with the substrate 108 (the contacting position Hc) is detected and on the basis of the result of this detection, the contact detection starting position in the next mounting process is corrected, the contact detection starting position can be corrected in each joining process, whereby it becomes possible to optimally secure the contact detection distance Ls and yet, bring the contact detection starting position Hc close to the substrate 108 at maximum. Therefore, it is possible to reliably avoid unexpected contact between the electronic part 100 and the substrate 108 and yet, minimize the tact time while maintaining the accuracy of contact detection at a desired level, whereby it becomes possible to make an improvement in the maintenance of the quality of products and a reduction in the cost of products compatible.

Now, the method of joining the electronic part (chip) and the substrate together in the mounting process apparatus described in the present embodiment can also be a method of applying an adhesive agent to the joint surface of one (or both) of the electronic part (chip) and the substrate, hardening the adhesive agent while urging the chip against the substrate on the basis of a carried profile, thereby joining the chip to the substrate.

Also, while in the present embodiment, the direction of contact between the electronic part and the substrate has been shown as the direction of gravity, of course, the direction of contact can be other direction than the direction of gravity, such as a horizontal direction.

The present invention is not restricted to the mounting process apparatus for mounting the electronic part on the substrate, but can be applied to a process apparatus for detecting the contact between an electronic part and a substrate, and applying some processing to a member to be processed.

Also, while in the present embodiment, description has been made of a construction in which the chip holding tool 101 side is moved relative to the substrate 108, there can also be adopted a construction in which the substrate holding means 109 side, i.e., a substrate stage (a base side supporting the substrate which is an object to be processed), is moved relative to the chip holding tool 101.

Of course, the layout of each element, each device, each mechanism, each member, etc. of the apparatus described in each of the foregoing embodiments is not restricted to what has been shown by way of example, but can be suitably changed.

As has hitherto been described, according to the present invention, the mounting process apparatus is comprised of:
a contact start detecting member adapted to move in operative association with moving means for moving at least one of a mounting part and a part to be mounted toward the other until the mounting part and the part to be mounted contact with each other, and on the other hand, when the mounting part and the part to be mounted have contacted with each other, to have its operative association with the moving means released in response to the action of the contact pressure thereof and be movable independently of the moving means; and
contact start detecting means for detecting the movement of the contact start detecting member to thereby detect the start of contact between the mounting part and the part to be mounted;
and is designed such that the start of contact between the mounting part and the part to be mounted is detected on the basis of the movement of the contact start detecting member and therefore, as compared with the prior art in which the start of contact between the electronic part and the substrate is detected on the basis of the detection value of the driving current of the motor or the detection value of the load cell, the stability of the detection can be made high in level and yet, the start of contact can be highly accurately detected, whereby the higher accuracy detected, whereby the higher accuracy and further, higher quality of the mounting process can be achieved.

The output member of the pressurizing means of the mounting process apparatus according to the present invention can be made to function as the contact start detecting member and accordingly, on the basis of the movement thereof, the start of contact between the mounting part and the part to be mounted can be detected and therefore, the simplification of the construction can be promoted and yet, as compared with the prior art in which the start of the contact between the electronic part and the substrate is detected on the basis of the detection value of the driving current of the motor or the detection value of the load cell, the stability of the detection can be made high in level and yet, the start of contact can be highly accurately detected, whereby the higher accuracy and further, higher quality of the mounting process can be achieved.

1. A contact start detecting apparatus for a mounting process apparatus comprised of:
a contact start detecting member adapted to move in operative association with moving means for moving at least one of a mounting part and a part to be mounted toward the other until the mounting part and the part to be mounted contact with each other, and on the other hand, when the mounting part and the part to be mounted have contacted with each other, to have its operative association with said moving means released in response to the action of the contact pressure thereof and be movable independently of said moving means; and
contact start detecting means for detecting the movement of said contact start detecting member to thereby detect the start of contact between the mounting part and the part to be mounted.

2. A contact start detecting apparatus according to claim 1, wherein said contact start detecting means detects the start of contact between the mounting part and the part to be mounted on the basis of the relative movement of one portion of said contact start detecting means disposed on said moving means and the other portion of said contact start detecting means disposed on said contact start detecting member.

3. A contact start detecting apparatus according to claim 2, wherein one of said one portion and said other portion is constructed as a detecting head comprised of a light source, a condensing lens and a light receiving element, and the other is constructed as a scale unit comprised of a scale portion and movable relative to said detecting head.

4. A mounting process apparatus comprised of a contact start detecting apparatus according to any one of claims 1 to 3, and adapted to process the mounting part and the part to be mounted in a predetermined manner on the basis of a result of the detection of the start of contact between the mounting part and the part to be mounted.

5. A mounting process apparatus comprised of;
mounting part holding means for holding a mounting part;
mounted part holding means for holding a part to be mounted;
moving means for moving at least one of the mounting part holding means and the mounted part holding means toward the other;
pressurizing means capable of causing an output member to act on one of the mounting part and the part to be mounted, and imparting a predetermined pressure force to between the mounting part and the part to be mounted contacting with each other;
regulating means for supporting said output member from a direction opposed to a pressurizing direction, and regulating the movement of said output member relative to the supporting portion in the pressurizing direction;
control means for bringing the mounting part and the part to be mounted into contact with each other through said moving means with said output member urged against said regulating means by said pressurizing means, moving said output member relative to said supporting portion by the contact pressure against said predetermined pressure force to thereby release the support by said regulating means, and processing the mounting part and the part to be mounted in a predetermined manner while imparting a predetermined pressure force through the output member of said pressurizing means; and
means for detecting the movement of said output member relative to said supporting portion by said contact pressure against said predetermined pressure force to thereby detect the start of contact between the mounting part and the part to be mounted;
wherein said control means processes the mounting part and the part to be mounted in a predetermined manner on the basis of the detection information of the means for detecting the start of contact between the mounting part and the part to be mounted while imparting the predetermined pressure force through the output member of said pressurizing means.

6. A mounting process apparatus according to claim 5, wherein the means for detecting the start of contact between said mounting part and said part to be mounted is comprised of a detecting head comprised of a light source, a condensing lens and a light receiving element, and disposed on one of said output member and said regulating means, and a scale unit comprised of a scale portion and movable relative to said detecting head, and disposed on the other.
